(19) United States
(12) Patent Application Publication
(10) Pub. No.: US 2026/0115866 A1
(43) Pub. Date: Apr. 30, 2026

(54) ABRASIVE WHEELS AND METHODS FOR MAKING AND USING SAME

(71) Applicants: SAINT-GOBAIN ABRASIVES, INC., Worcester, MA (US); SAINT-GOBAIN ABRASIFS, Conflans-Sainte-Honorine (FR)

(72) Inventors: Tyler B. CICHOWLAS, Sudbury, MA (US); Jing DONG, Shrewsbury, MA (US); Anthony MARTONE, Belmont, MA (US); Hua FAN, Southborough, MA (US)

(21) Appl. No.: 19/003,542

(22) Filed: Dec. 27, 2024

Related U.S. Application Data
(60) Provisional application No. 63/615,756, filed on Dec. 28, 2023.

(51) Int. Cl. B24D 5/02

(52) U.S. Cl. CPC B24D 5/02

(57) ABSTRACT

A bonded abrasive comprising a body including abrasive particles contained within a bond material, wherein the abrasive particles comprise a first group of abrasive particles in a first content (C1), the first group including shaped abrasive particles having a first average particle size (PS1) and a second group of abrasive particles in a second content (C2), the second group including non-shaped abrasive particles having a second average particle size (PS2), wherein PS2<PS1 and a content ratio (C2/C1) of at least 0.05 to 1.

### CROSS-REFERENCE TO RELATED APPLICATION(S)

This application claims priority under 35 U.S.C. § 119(c) to U.S. Provisional Application No. 63/615,756, entitled “ABRASIVE WHEELS AND METHODS FOR MAKING AND USING SAME,” by Tyler B. CICHOWLAS et al., filed Dec. 28, 2023, which is assigned to the current assignee hereof and incorporated herein by reference in its entirety.

### BACKGROUND

Typically, bonded abrasive articles are prepared by blending abrasive particles with a bond and optional additives and shaping the resulting mixture by using, for instance, a suitable mold. The mixture can be shaped to form a green body which is thermally processed, for example, by curing, sintering and so forth, to produce an article in which the abrasive particles are held in a three-dimensional bond matrix. In some cases, the green body can be cold processed to form the bonded abrasive article. Among bonded abrasive tools, abrasive wheels often are prepared for grinding, cutting, polishing, and the like. Such wheels can be reinforced using, for example, discs cut out of nylon, carbon, glass, or cotton cloth, or they may not be reinforced.

### SUMMARY

The disclosure generally relates to bonded abrasive articles and in particular to abrasive wheels suitable for use as a cut-off wheel and to methods for producing such abrasive wheels.

In one aspect, the disclosure is directed to a bonded abrasive comprising a body including abrasive particles contained within a bond material. The abrasive particles comprise a first group of abrasive particles in a first content (C1). The first group including shaped abrasive particles having a first average particle size (PS1) and a second group of abrasive particles in a second content (C2). The second group including non-shaped abrasive particles having a second average particle size (PS2), wherein PS2<PS1 and a content ratio (C2/C1) of at least 0.05 to 1.

The above and other features described herein including various details of construction and combinations of parts, and other advantages, will now be more particularly described with reference to the accompanying drawings and pointed out in the claims. It will be understood that the particular method and article embody certain features that are shown by way of illustration and not as limitations and that the principles and features described herein may be employed in various and numerous embodiments.

### BRIEF DESCRIPTION OF THE DRAWINGS

In the accompanying drawings, reference characters refer to the same parts throughout the different views. The drawings are not necessarily to scale.

FIG. 1 includes a flow diagram of a method to make a bonded abrasive according to one embodiment.

FIG. 2 includes a side view of a bonded abrasive in accordance with an embodiment.

FIG. 3 includes cross-sectional view of the bonded abrasive of FIG. 2 according to an embodiment.

FIG. 4 includes a cross-sectional view of the bonded abrasive in accordance with an alternative embodiment.

FIG. 5 includes a cross-sectional view of the bonded abrasive in accordance with an alternative embodiment.

FIG. 6 includes a perspective view illustration of a shaped abrasive particle according to an embodiment.

FIG. 7 includes a perspective view illustration of a shaped abrasive particle in accordance with an embodiment.

FIG. 8A includes an image of a 3-PT star-shaped abrasive particle.

FIG. 8B includes an illustration of a side view of the shaped abrasive particle of FIG. 8A.

FIG. 9 includes a photograph of 3-PT star-shaped abrasive particles and 3-PT star shard particles in accordance with an embodiment.

FIG. 10 includes an image of a 3-PT star shard particle.

### DETAILED DESCRIPTION

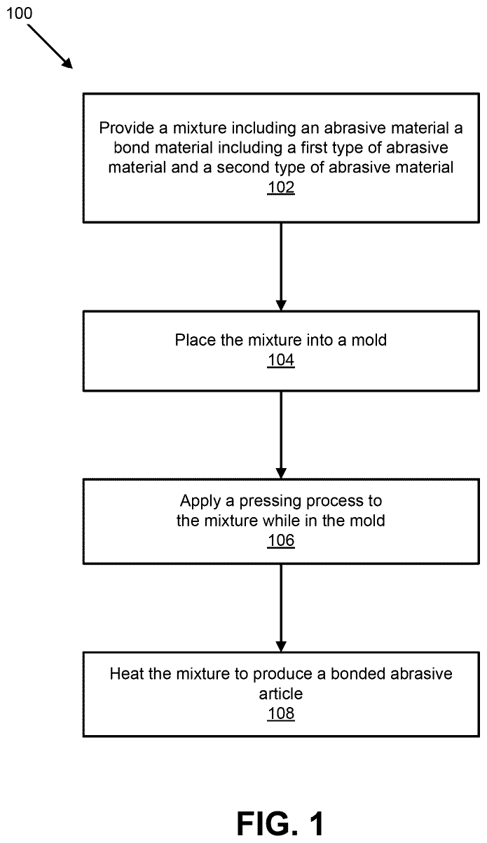

The disclosure generally relates to bonded abrasive articles, and in particular, to cutting wheels suitable for use as a cut-off wheel or a chop saw and to methods for producing the same. FIG. 1 includes a flow diagram of a method 100 to make a bonded abrasive article according to one embodiment. In particular, at 102, the method 100 includes providing a mixture including abrasive particles and a bond material. In accordance with an embodiment, the bond material can include materials such as vitreous, polycrystalline, monocrystalline, organic (e.g., resin), metal, metal alloys, and a combination thereof. The mixture can also include additional components, such as processing aids, lubricants (e.g., wetting agents), curing agents, crosslinking agents, antistatic agents, a porosity inducer, coloring agents, and the like.

In an embodiment, the mixture may include a particular amount of abrasive particles that may facilitate improved manufacturing and/or performance of the bonded abrasive. In a particular embodiment, the mixture may comprise at least about 10 wt % abrasive particles for a total weight of the mixture, or at least 15 wt % or at least 20 wt % or at least 25 wt % or at least 30 wt % or at least 35 wt % or at least 40 wt % or at least 45 wt % or at least 50 wt % or at least 55 wt % or at least 60 wt %. In another embodiment, the mixture includes no greater than about 95 wt % abrasive particles for a total weight of the mixture, or not greater than 90 wt % or not greater than 85 wt % or not greater than 80 wt % or not greater than 75 wt % or not greater than 70 wt % or not greater than 65 wt % or not greater than 60 wt % or not greater than 55 wt %. It will be appreciated that the content of abrasive particles in the mixture can be within a range between any of the values noted above. In a particular embodiment, the mixture can include abrasive particles within a range of about 10 wt % to about 95 wt % abrasive particles for a total weight of the mixture.

According to one aspect, the mixture can include more than one type of abrasive particle, where different types of abrasive particles can differ from each other based on at least one characteristic selected from the group of particle size, two-dimensional shape, three-dimensional shape, composition, hardness, toughness, friability, density, grain size, agglomeration state, or any combination thereof. In an embodiment, the abrasive particles can include a first group of shaped abrasive particles having a first content (C1) and a second group of abrasive particles having a second content (C2). In a particular embodiment, at least about 50% of a total content of the abrasive particles includes the first group of shaped abrasive particles (C1), or at least 51% or at least 52% or at least 53% or at least 54% or at least 55% or at least 56% or at least 57% or at least 58% or at least 59% or at least 60% or at least 61% or at least 62% or at least 63% or at least 64% or at least 65% or at least 66% or at least 67% or at least 68% or at least 69% or at least 70%. For example, in some instances, not greater than 90% of a total content of the abrasive particles includes the first group of shaped abrasive particles (C1), or not greater than 89% or not greater than 88% or not greater than 87% or not greater than 86% or not greater than 85% or not greater than 84% or not greater than 83% or not greater than 82% or not greater than 81% or not greater than 80% or not greater than 79% or not greater than 78% or not greater than 77% or not greater than 76% or not greater than 75%. It will be appreciated that the content of the abrasive particles including the first group of shaped abrasive particles (C1) can be within a range between any of the values noted above. In a particular illustrative embodiment, the content of the abrasive particles including the first group of shaped abrasive particles (C1) can be within a range of about 50 wt % to about 90 wt %.

In an embodiment, the abrasive particles can include a second group of abrasive particles having a second content (C2). In a particular embodiment, at least about 10% of a total content of the abrasive particles includes the second group of abrasive particles (C2), or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30%. For example, in some instances, not greater than 50% of a total content of the abrasive particles includes the second group of abrasive particles (C2), or not greater than 49% or not greater than 48% or not greater than 47% or not greater than 46% or not greater than 45% or not greater than 44% or not greater than 43% or not greater than 42% or not greater than 41% or not greater than 40% or not greater than 39% or not greater than 38% or not greater than 37% or not greater than 36% or not greater than 35% or not greater than 34% or not greater than 33% or not greater than 32% or not greater than 31% or not greater than 30%. It will be appreciated that the content of the abrasive particles including the second group of abrasive particles (C2) can be within a range between any of the values noted above. In a particular illustrative embodiment, the content of the abrasive particles including the second group of abrasive particles (C2) can be within a range of about 10 wt % to about 50 wt %.

In still other embodiment, the mixture of finally formed bonded abrasive may include a content ratio (C2/C1) of the second content (C2) to the first content (C1) that may facilitate improved manufacturing and/or performance of the bonded abrasive. In a particular embodiment, the content ratio (C2/C1) may be at least 0.11 or at least 0.2 or at least 0.3 or at least 0.4 or at least 0.41 or at least 0.42. In another aspect, the content ratio (C2/C1) may be not greater than 0.99 or not greater than 0.95 or not greater than 0.9 or not greater than 0.85 or not greater than 0.8 or not greater than 0.75 or not greater than 0.7 or not greater than 0.65 or not greater than 0.6 or not greater than 0.55 or not greater than 0.5. The content ratio (C2/C1) may be a value between any of the minimum and maximum values noted above, including for example, but not limited to within a range of at least 0.11 to not greater than 0.99 such as within a range from at least 0.3 to not greater than 0.7.

In still another embodiment, the mixture or finally formed bonded abrasive may include a first group of abrasive particles having a first particle size (PS1) that may facilitate improved manufacturing and/or performance of the bonded abrasive. In a particular embodiment, a first group of abrasive particles may have a first particle size (PS1) of at least 200 microns or at least 210 microns or at least 220 microns or at least 230 microns or at least 240 microns or at least 250 microns or at least 260 microns or at least 270 microns or at least 280 microns or at least 290 microns or at least 300 microns or at least 310 microns or at least 320 microns or at least 330 microns or at least 340 microns or at least 350 microns or at least 400 microns or at least 450 microns or at least 500 microns or at least 550 microns or at least 600 microns or at least 650 microns or at least 700 microns or at least 750 microns or at least 800 microns or at least 850 microns or at least 900 microns or at least 950 microns or at least 1000 microns or at least 1050 microns or at least 1100 microns or at least 1150 microns or at least 1200 microns or at least 1250 microns or at least 1300 microns or at least 1350 microns or at least 1400 microns. In another aspect, the first group of abrasive particles may have a first particle size (PS1) not greater than 3000 microns or not greater than 2500 microns or not greater than 2000 microns or not greater than 1900 microns or not greater than 1800 microns or not greater than 1700 microns or not greater than 1600 microns or not greater than 1500 microns or not greater than 1400 microns. The first group of abrasive particles may have a first particle size (PS1) that may be a value between any of the minimum and maximum values noted above, including for example, but not limited to within a range of at least 200 microns to not greater than 3000 microns such as within a range from at least 300 microns to not greater than 1500 microns.

In still another embodiment, the mixture or finally formed bonded abrasive may include a second group of abrasive particles having a first particle size (PS2) that may facilitate improved manufacturing and/or performance of the bonded abrasive. In a particular embodiment, a second group of abrasive particles may have a first particle size (PS2) of at least 1 micron or at least 5 microns or at least 10 microns or at least 20 microns or at least 30 microns or at least 40 microns or at least 50 microns or at least 60 microns or at least 70 microns or at least 80 microns or at least 90 microns or at least 100 microns or at least 110 microns or at least 120 microns or at least 130 microns or at least 140 microns or at least 150 microns or at least 160 microns or at least 170 microns or at least 180 microns or at least 190 microns. In another aspect, the second group of abrasive particles may have a first particle size (PS2) not greater than 500 microns or not greater than 440 microns or not greater than 420 microns or not greater than 400 microns or not greater than 380 microns or not greater than 360 microns or not greater than 340 microns or not greater than 320 microns or not greater than or not greater than 300 microns or not greater than 280 microns or not greater than 260 microns or not greater than 240 microns or not greater than 220 microns or not greater than 200 microns or not greater than 190 microns. The second group of abrasive particles may have a first particle size (PS2) that may be a value between any of the minimum and maximum values noted above, including for example, but not limited to within a range of at least 1 micron to not greater than 500 microns such as within a range from at least 50 microns to not greater than 200 microns.

In still another embodiment, the mixture or finally formed bonded abrasive may include a particle size ratio (PS1:PS2) of the first average particle size (PS1) to the second average particle size (PS2) that may facilitate improved manufacturing and/or performance of the bonded abrasive. In a particular embodiment, the particle size ratio (PS1:PS2) of the first average particle size (PS1) to the second average particle size (PS2) may be at least 1 or at least 1.1 or at least 1.2 or at least 1.3 or at least 1.4 or at least 1.5 or at least 1.6 or at least 1.7 or at least 1.8 or at least, 1.9 or at least 2 or at least 3 or at least 4 or at least 5 or at least 6 or at least 7 or at least 8 or at least 9 or at least 10 or at least 11 or at least 12 or at least 13 or at least 14 or at least 15. In another aspect, the particle size ratio (PS1:PS2) of the first average particle size (PS1) to the second average particle size (PS2) may be not greater than 20 or not greater than 19 or not greater than 18 or not greater than 17 or not greater than 16 or not greater than 15 or not greater than 14 or not greater than 13 or not greater than 12 or not greater than 11 or not greater than 10 or not greater than 9 or not greater than 8 or not greater than 7 or not greater than 6 or not greater than 5 or not greater than 4 or not greater than 3. The particle size ratio (PS1:PS2) may be a value between any of the minimum and maximum values noted above, including for example, but not limited to within a range of at least 1 to not greater than 20 such as within a range from at least 2 to not greater than 10.

The abrasive particles of the embodiments herein can include particular types of abrasive particles. For example, the abrasive particles of the first group may include shaped abrasive particles and/or elongated abrasive particles, wherein the elongated abrasive particles may include an aspect ratio of length:width or length:height of at least 1.1:1. Various methods may be utilized to obtain shaped abrasive particles. The particles may be obtained from a commercial source or fabricated. Some suitable processes used to fabricate the shaped abrasive particles can include, but is not limited to, depositing, printing (e.g., screen-printing), molding, pressing, casting, sectioning, cutting, dicing, punching, pressing, drying, curing, coating, extruding, rolling, and a combination thereof. Similar processes may be utilized to obtain elongated abrasive particles. Elongated un-shaped abrasive particles may be formed through crushing and sieving techniques.

FIG. 6 includes a perspective view illustration of a shaped abrasive particle in accordance with an embodiment. The shaped abrasive particle 600 can include a body 601 including a major surface 602, a major surface 603, and a side surface 604 extending between the major surfaces 602 and 603. As illustrated in FIG. 6, the body 601 of the shaped abrasive particle 600 is a thin-shaped body, wherein the major surfaces 602 and 603 are larger than the side surface 604. Moreover, the body 601 can include a longitudinal axis 610 extending from a point or corner of the shaped abrasive particle 600 to a base (e.g., an edge of the shaped abrasive particle 600 opposite the point or corner) and through the midpoint 650 on the major surface 602. The longitudinal axis 610 can define the longest dimension of a major surface while also extending through the midpoint 650 of the major surface. The body 601 can further include a lateral axis 611 defining a width of the body 601 extending generally perpendicular to the longitudinal axis 610 on the same major surface 602. Finally, as illustrated, the body 601 can include a vertical axis 612, which in the context of thin shaped bodies can define a height (or thickness) of the body 601. For thin-shaped bodies, the length of the longitudinal axis 610 is equal to or greater than the vertical axis 612. As illustrated, the thickness 612 can extend along the side surface 604 between the major surfaces 602 and 603 and perpendicular to the plane defined by the longitudinal axis 610 and lateral axis 611. It will be appreciated that reference herein to length, width, and height of the abrasive particles may be referenced to average values taken from a suitable sampling size of abrasive particles of a batch.

The shaped abrasive particles can include any of the features of the abrasive particles of the embodiments herein. For example, the shaped abrasive particles can include a crystalline material, and more particularly, a polycrystalline material. Notably, the polycrystalline material can include abrasive grains. In one embodiment, the body of the abrasive particle, including for example, the body of a shaped abrasive particle can be essentially free of an organic material, including for example, a binder. In at least one embodiment, the abrasive particles can consist essentially of a polycrystalline material.

Some suitable materials for use as abrasive particles of the first group of shaped abrasive particles and the second group of abrasive particles can include nitrides, oxides, carbides, borides, oxynitrides, oxyborides, diamond, carbon-containing materials, and a combination thereof. In particular instances, the abrasive particles can include an oxide compound or complex, such as aluminum oxide, zirconium oxide, titanium oxide, yttrium oxide, chromium oxide, strontium oxide, silicon oxide, magnesium oxide, rare-earth oxides, and a combination thereof. In one particular embodiment, the abrasive particles can include at least 95 wt % alumina for the total weight of the body. In at least one embodiment, the abrasive particles can consist essentially of alumina. Still, in certain instances, the abrasive particles can include not greater than 99.5 wt % alumina for the total weight of the body. Moreover, in particular instances, the shaped abrasive particles can be formed from a seeded sol-gel. In at least one embodiment, the abrasive particles of the embodiments herein may be essentially free of iron, rare-earth oxides, and a combination thereof. In still another embodiment, the first group of abrasive particles and the second group of abrasive particles may be composed of different materials.

FIG. 6 includes an illustration of a shaped abrasive particle having a two-dimensional shape as defined by the planes of the major surfaces 602 or 603, each of which has a generally triangular two-dimensional shape. It will be appreciated that the shaped abrasive particles of the embodiments herein are not so limited and can include other two-dimensional shapes. For example, the shaped abrasive particles of the embodiment herein can include particles having a body with a two-dimensional shape as defined by a major surface of the body from the group of shapes including polygons, irregular polygons, irregular polygons including arcuate or curved sides or portions of sides, ellipsoids, numerals, Greek alphabet characters, Latin alphabet characters, Russian alphabet characters, Kanji characters, complex shapes having a combination of polygons shapes, star shapes, and a combination thereof.

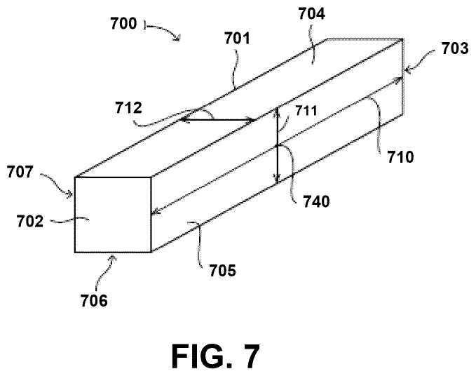

FIG. 7 includes a perspective view illustration of a shaped abrasive particle according to an embodiment. Notably, the shaped abrasive particle 700 can include a body 701 including a surface 702 and a surface 703, which may be referred to as end surfaces 702 and 703. The body can further include surfaces 704, 705, 706, 707 extending between and coupled to the end surfaces 702 and 703. The shaped abrasive particle of FIG. 7A is an elongated shaped abrasive particle having a longitudinal axis 710 that extends along the surface 705 and through the midpoint 740 between the end surfaces 702 and 703. It will be appreciated that the surface 705 is selected for illustrating the longitudinal axis 710, because the body 701 has a generally square cross-sectional contour as defined by the end surfaces 702 and 703. As such, the surfaces 704, 705, 706, and 707 have approximately the same size relative to each other. However, in the context of other elongated abrasive particles wherein the surfaces 702 and 703 define a different shape, for example, a rectangular shape, wherein one of the surfaces 704, 705, 706, and 707 may be larger relative to the others, the largest of those surfaces defines the major surface and, therefore, the longitudinal axis would extend along the largest of those surfaces. As further illustrated, the body 701 can include a lateral axis 711 extending perpendicular to the longitudinal axis 710 within the same plane defined by the surface 705. As further illustrated, the body 701 can further include a vertical axis 712 defining a height of the abrasive particle, wherein the vertical axis 712 extends in a direction perpendicular to the plane defined by the longitudinal axis 710 and lateral axis 711 of the surface 705.

It will be appreciated that, like the thin shaped abrasive particle of FIG. 6, the elongated shaped abrasive particle of FIG. 7A can have various two-dimensional shapes such as those defined with respect to the shaped abrasive particle of FIG. 6. The two-dimensional shape of the body 701 can be defined by the shape of the perimeter of the end surfaces 702 and 703. The elongated shaped abrasive particle 700 can have any of the attributes of the shaped abrasive particles of the embodiments herein.

Shaped abrasive particles may be formed through particular processes, including molding, printing, casting, extrusion, and the like. Shaped abrasive particles are formed such that each particle has substantially the same arrangement of surfaces and edges relative to each other. For example, a group of shaped abrasive particles generally have the same arrangement and orientation and or two-dimensional shape of the surfaces and edges relative to each other. As such, the shaped abrasive particles have a high shape fidelity and consistency in the arrangement and orientation of the surfaces and edges relative to each other. By contrast, non-shaped abrasive particles can be formed through different processes and have different shape attributes. For example, crushed grains are typically formed by a comminution process wherein a mass of material is formed and then crushed and sieved to obtain abrasive particles of a certain size. However, a non-shaped abrasive particle will have a generally random arrangement of the surfaces and edges, and generally will lack any recognizable two-dimensional or three-dimensional shape in the arrangement of the surfaces and edges. Moreover, the non-shaped abrasive particles do not necessarily have a consistent shape with respect to each other and therefore have a significantly lower shape fidelity compared to shaped abrasive particles. The non-shaped abrasive particles generally are defined by a random arrangement of surfaces and edges with respect to each other.

In an embodiment, the plurality of shaped abrasive particles can include a plurality of shaped abrasive particles having a 3-PT star two-dimensional shape as viewed in a plane of a length and width of the body. The body can include at least 3 exterior corners and at least 4 side surface sections, or at least 5 side surface sections or at least 6 side surface sections. In an embodiment, the plurality of shaped abrasive particles can include a body having at least 3 exterior corners, where the sum of the angles of the exterior corners is less than 180 degrees. In an embodiment, the plurality of shaped abrasive particles can include a body having at least 3 exterior corners, where each of the exterior corners defines an angle less than 60 degrees or less than 59 degrees or less than 58 degrees or less than 57 degrees or less than 56 degrees or less than 55 degrees. In an embodiment, the plurality of shaped abrasive particles can include a body having at least 3 exterior corners and at least 3 interior corners, where each of the interior corners have an interior corner angle value greater than any of the exterior corner values of any of the at least 3 exterior corners.

Exterior corners can be identified using the “rubber band test.” If a rubber band were to be stretched around the body of the abrasive particle, the corners that contact the rubber band and cause deflection of the rubber band would be exterior corners.

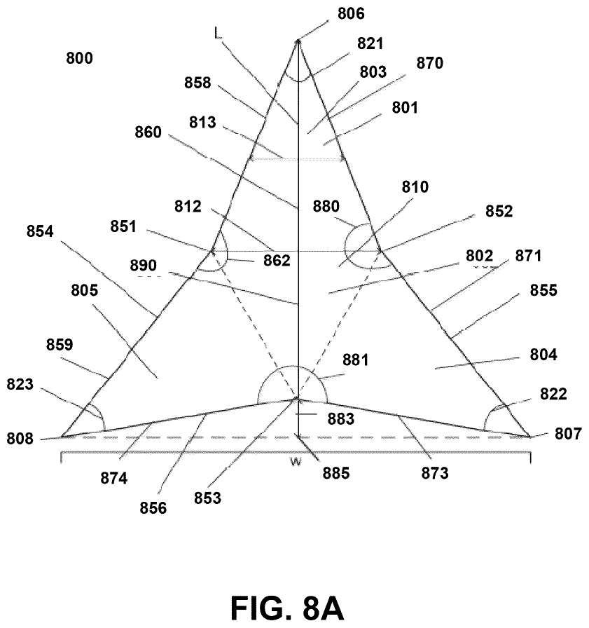

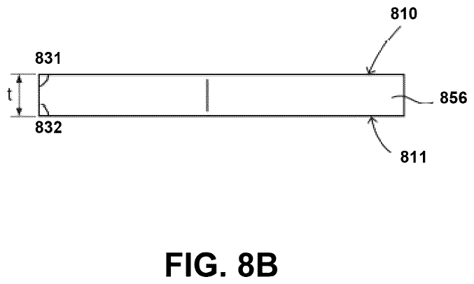

FIG. 8A includes a top view image of a 3-PT star-shaped abrasive particle according to a particular embodiment. As illustrated, the shaped abrasive particle 800 can define a star-shaped body, as viewed in two dimensions. In particular, the shaped abrasive particle 800 can include a body 801 having a central portion 802 and a first arm 803, a second arm 804, and a third arm 805 extending from the central portion 802. The body 801 can have a length (l) measured as the longest dimension along a side of the particle and a width (w), measured as the longest dimension of the particle between a midpoint 853 of a side through the midpoint 890 of the body 801 to a first tip 806 of the first arm 803. The width can extend in a direction perpendicular to the dimension of the length. The body 801 can have a thickness (t), extending in a direction perpendicular to the upper surface or first major surface 810 of the body 801 defining the third side surface 856 between the upper surface or first major surface 810 and the base surface 811 as illustrated in FIG. 8B, which is a side view illustration of the image of the particle of FIG. 8A.

The shaped abrasive particle 800 can have a body 801 in the form of a 3-PT star defined by the first arm 803, second arm 804, and the third arm 805 extending from the central portion 802. According to one particular embodiment, at least one of the arms, including, for example, the first arm 803, can have a midpoint width 813 that is less than a central portion width 812. The central portion 802 can be defined as a region between the midpoints 851, 852, and 853 of the first side surface 854, second side surface 855, and third side surface 856, respectively. The central portion width 812 of the first arm 803 can be the width of the dimension between the midpoints 851 and 852. The midpoint width 813 can be the width of the line at a midpoint between the line of the central portion width 812 and the tip 806 of the first arm 803 along a first axis 860. In certain instances, the midpoint width 813 can be not greater than about 90% of the central portion width 812, such as not greater than about 80%, or not greater than about 70%, or not greater than about 5%, or even not greater than about 60%. Still, the midpoint width 813 can be at least about 10%, such as at least about 20%, or at least about 30%, or even at least about 40% of the central portion width 812. It will be appreciated that the midpoint width 813 can have a width relative to the central portion width 812 within a range between any of the above minimum and maximum percentages.

Moreover, the body 801 can have at least one arm, such as the first arm 803, having a tip width at the tip 806 of the first arm 803 that is less than a midpoint width 813. In such instances wherein the tip 806 is sharply formed, the tip width may be considered 0. In instances wherein the tip 806 has a radius of curvature, the tip width may be considered the diameter of the circle defined by the radius of curvature. According to one embodiment, the tip width 814 can be not greater than about 90% of the midpoint width 813, such as not greater than about 80%, or not greater than about 70%, or not greater than about 60%, or not greater than about 50%, or not greater than about 40%, or not greater than about 30%, or not greater than about 20%, or even not greater than about 10%. Still, in certain non-limiting embodiments, the tip width 814 can be at least about 1%, such as at least about 2%, or at least about 3%, or at least about 5%, or even at least about 10% of the midpoint width 813. It will be appreciated that the tip width 814 can have a width relative to the midpoint width 813 within a range between any of the above minimum and maximum percentages.

As further illustrated, the body 801 can have a first arm 803 including a first tip 806 defining a first tip angle 821 between the first side surface 854 and the second side surface 855. According to an embodiment, the first tip angle can be less than about 60 degrees, such as not greater than about 55 degrees, or not greater than about 50 degrees, or not greater than about 45 degrees, or even not greater than about 40 degrees. Still, the first tip angle can be at least about 5 degrees, such as at least about 8 degrees, or at least about 10 degrees, or at least about 15 degrees, or at least about 20 degrees, or at least about 25 degrees, or even at least about 30 degrees. The first tip angle can be within a range between any of the minimum and maximum values noted above.

The body 801 can include a second arm 804 having a second tip 807 defining a second tip angle 822 between the second side surface 855 and third side surface 856. The second tip angle can be substantially the same as the first tip angle, such as within 5% of the angle numerical value. Alternatively, the second tip angle can be substantially different relative to the first tip angle.

The body 801 can include a third arm 805 having a third tip 808 defining a third tip angle 823 between the first side surface 854 and third side surface 856. The third tip angle can be substantially the same as the first tip angle or second tip angle, such as within 5% of the angle numerical value. Alternatively, the third tip angle can be substantially different relative to the first tip angle or the second tip angle.

The body 801 can have a total angle, which is a sum of the value of the first tip angle, second tip angle, and third tip angle, which can be less than about 180 degrees. In other embodiments, the total angle can be not greater than about 175 degrees, such as not greater than about 170 degrees, or not greater than about 160 degrees, or not greater than about 150 degrees, such as not greater than about 140 degrees, or not greater than about 130 degrees, or not greater than about 125 degrees, or even not greater than about 120 degrees. Still, in one non-limiting embodiment, the body 801 can have a total angle of at least about 60 degrees, such as at least about 70 degrees, or at least about 80 degrees, or at least about 90 degrees, such as at least about 95 degrees, or at least about 100 degrees, or even at least about 105 degrees. It will be appreciated that the total sum angle can be within a range between any of the minimum and maximum values noted above.

As noted herein, the body 801 can have a first side surface 854 extending between the first arm 806 and the third arm 808. In certain instances, the first side surface 854 can have an arcuate contour.

Referring again to FIG. 8A, the body 801 can have a first side surface 854 having a first side section 858 and a second side section 859. The first side section 858 can extend between the first tip 806 and the midpoint 851, and the second side section 859 can extend between the third tip 808 and the midpoint 851. The first side section 858 and second side section 859 can define an interior angle 862 that can be obtuse. For example, the interior angle 862 can be greater than about 90 degrees, such as greater than about 95 degrees, or greater than about 100 degrees, or greater than about 110 degrees, or even greater than about 120 degrees. Still, in one non-limiting embodiment, the interior angle 862 can be not greater than about 320 degrees, such as not greater than about 300 degrees, or even not greater than about 270 degrees. It will be appreciated that the interior angle can be within a range between any of the minimum and maximum values noted above.

Referring again to FIG. 8A, the body 801 can have a second side surface 855 having a third side section 870 and a fourth side section 871. The third side section 870 can extend between the first tip 806 and the midpoint 852, and the fourth side section 871 can extend between the second tip 807 and the midpoint 852. The third side section 870 and fourth side section 871 can define an interior angle 880 that can be obtuse. For example, the interior angle 880 can be greater than about 90 degrees, such as greater than about 95 degrees, or greater than about 100 degrees, or greater than about 110 degrees, or even greater than about 120 degrees. Still, in one non-limiting embodiment, the interior angle 880 can be not greater than about 320 degrees, such as not greater than about 300 degrees, or even not greater than about 270 degrees. It will be appreciated that the interior angle can be within a range between any of the minimum and maximum values noted above.

Referring again to FIG. 8A, the body 801 can have a third side surface 856 having a fifth side section 873 and a sixth side section 874. The fifth side section 873 can extend between the second tip 807 and the midpoint 853, and the sixth side section 874 can extend between the third tip 808 and the midpoint 853. The fifth side section 873 and sixth side section 874 can define an interior angle 881 that can be obtuse. For example, the interior angle 881 can be greater than about 90 degrees, such as greater than about 95 degrees, or greater than about 100 degrees, or greater than about 110 degrees, or even greater than about 120 degrees. Still, in one non-limiting embodiment, the interior angle 881 can be not greater than about 320 degrees, such as not greater than about 300 degrees, or even not greater than about 270 degrees. It will be appreciated that the interior angle can be within a range between any of the minimum and maximum values noted above.

In still another embodiment, the body 801 can have a concavity depth 883 formed by the fifth side section 873 and the sixth side section 874. In an embodiment, the concavity depth 883 can be measured along the first axis 860 between the midpoint 853 and a length endpoint 885 where the length endpoint 885 represents the length of the shaped abrasive particle measured beyond the midpoint 853 along the first axis 860. In a particular embodiment, the concavity depth 883 can be at least 1 micron, such as at least 5 microns, or at least 10 microns, or at least 15 microns, or at least 20 microns, or at least 25 microns, or at least 30 microns, or at least 35 microns, or at least 40 microns, or at least 45 microns, or at least 50 microns, or at least 55 microns, or at least 60 microns, or at least 65 microns, or at least 75 microns, or at least 80 microns, or at least 85 microns, or at least 90 microns, or at least 95 microns or at least 100 microns. Still, in on non-limiting embodiment, the concavity depth 883 can be not greater than 500 microns, or not greater than 400 microns, or not greater than 300 microns, or not greater than 200 microns, or not greater than 150 microns, or not greater than 120 microns, or not greater than 110 microns, or not greater than 100 microns. It will be appreciated that the concavity depth 883 can be within a range between any of the minimum and maximum values noted above such as between at least 1 micron and not greater than 1000 microns or at least 10 microns and not greater than 500 microns. It will also be appreciated that the first side section 858 and the second side section 859 can form a concavity depth having any of the values as described above with respect to the concavity depth 883. It will also be appreciated that the third side section 870 and the fourth side section 871 can form a concavity depth having any of the values as described above with respect to the concavity depth 883.

The first side section 858 can extend for a significant portion of the length of the first side surface 854. For example, the first side section 858 can extend for at least about 20%, such as at least about 25%, or at least about 30%, or at least about 35%, or even at least about 40% of a total length of the first side surface 854. Still, in one non-limiting embodiment, the first side section 858 can have a length (ls1) between the midpoint 851 and the first tip 806 of not greater than about 80%, such as not greater than about 75%, not greater than about 70%, or even not greater than about 5% of the total length of the side surface 854. It will be appreciated that the length of the first side section 858 can be within a range between any of the minimum and maximum percentages noted above.

The second side section 859 can extend for a significant portion of the length of the first side surface 854. For example, the second side section 859 can extend for at least about 20%, such as at least about 25%, or at least about 30%, or at least about 35%, or even at least about 40% of a total length of the first side surface 854. Still, in one non-limiting embodiment, the second side section 859 can have a length (ls2) between the midpoint 851 and the third tip 808 of not greater than about 80%, such as not greater than about 75%, not greater than about 70%, or even not greater than about 5% of the total length of the side surface 854 as a straight line between the first tip 806 and the third tip 808. It will be appreciated that the length of the second side section 859 can be within a range between any of the minimum and maximum percentages noted above.

The body 801 can include a first average side surface angle 831 between the side surfaces 854, 855, and 856 and the upper surface or first major surface 810. The body can also include a second side surface angle 832 between the side surfaces 854, 855, and 856 and the second major surface or base surface 812.

In an embodiment, the abrasive particles may include a particular first side surface angle that may facilitate improved performance and/or manufacturing of the abrasive particles. In an embodiment, the first side surface angle can be at least 45 degrees or at least 50 degrees or at least 55 degrees or at least 60 degrees or at least 65 degrees or at least 70 degrees. In still another embodiment, the first side surface angle can be not greater than 95 degrees or not greater than 90 degrees or not greater than 85 degrees or not greater than 80 degrees. It will be appreciated that the first side surface angle can be within a range between any of the minimum and maximum percentages noted above such as within a range of at least 45 degrees and not greater than 95 degrees or within a range of at least 50 degrees and not greater than 90 degrees or within a range of at least 55 degrees and not greater than 85 degrees.

In an embodiment, the abrasive particles may include a particular second side surface angle that may facilitate improved performance and/or manufacturing of the abrasive particles. In an embodiment, the second side surface angle can be at least 45 degrees or at least 50 degrees or at least 55 degrees or at least 60 degrees or at least 65 degrees or at least 70 degrees. In still another embodiment, the second side surface angle can be not greater than 95 degrees or not greater than 90 degrees or not greater than 85 degrees or not greater than 80 degrees. It will be appreciated that the second side surface angle can be within a range between any of the minimum and maximum percentages noted above such as within a range of at least 45 degrees and not greater than 95 degrees or within a range of at least 50 degrees and not greater than 90 degrees or within a range of at least 55 degrees and not greater than 85 degrees.

While the foregoing body 801 of the 3-PT star has been shown to have an upper surface 810 having a two-dimensional shape, as viewed in the plane of the length and width of the body, that is substantially the same as the two-dimensional shape of the base surface or second major surface 811 of the body 801, other shapes are contemplated. For example, in one embodiment, the cross-sectional shape of the body at the base surface can define a base surface shape from the group consisting of a 3-PT star, a 4-PT star, a cross-shape, a polygon, ellipsoids, numerals, Greek alphabet characters, Latin alphabet characters, Russian alphabet characters, complex shapes having a combination of polygonal shapes, and a combination thereof. Furthermore, the cross-sectional shape of the body may comprise a two-dimensional shape as viewed in a plane of a length and width of the body having an odd number of exterior points. For example, the body may comprise at least 3 exterior points, or at least 5 exterior points, or at least 7 exterior points. Moreover, the cross-sectional shape of the body at the upper surface can define an upper surface shape, which can be different than the base surface shape and selected from the group of a 3-PT star, a 4-PT star, a cross-shape, a polygon, ellipsoids, numerals, Greek alphabet characters, Latin alphabet characters, Russian alphabet characters, complex shapes having a combination of polygonal shapes, and a combination thereof.

In particular instances, the upper surface shape can have an arcuate form of the base surface shape. For example, the upper surface shape can define an arcuate 3-PT two-dimensional shape, wherein the arcuate 3-PT two-dimensional shape defines arms having rounded ends. In particular, the arms as defined at the base surface can have a smaller radius of curvature at the tip as compared to the radius of curvature of the corresponding tip at the upper surface.

As described in other embodiments herein, it will be appreciated that at least one of the arms of the body 801 may be formed to have a twist, such that the arm twists around a central axis. For example, the first arm 803 may twist around the axis 860. Moreover, the body 801 can be formed such that at least one arm extends in an arcuate path from the central region.

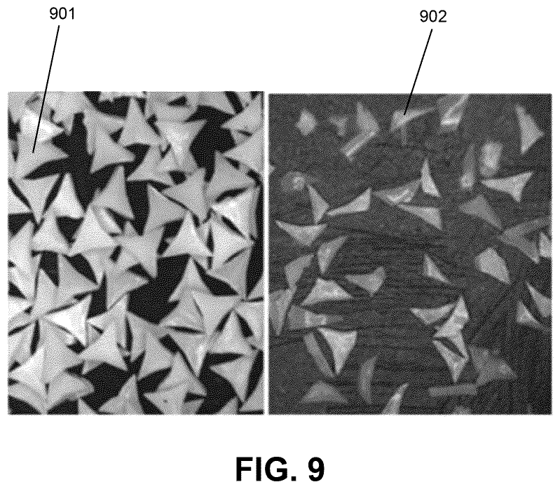

In an embodiment, the plurality of shaped abrasive particles can include a plurality of 3-PT star shard particles as viewed in a plane of a length and width of the body. FIG. 9 includes a photograph of 3-PT star-shaped abrasive particles 901 and 3-PT star shard particles 902. As can be seen in FIG. 9, the 3-PT star shard particles 902 are abrasive shards formed from the 3-PT star-shaped abrasive particles 901. In an embodiment, a 3-PT star shard particle 902 can result from the manufacturing process of the 3-PT star-shaped abrasive particles 901 such as extrusion, molding, screen printing, rolling, melting, pressing, casting, segmenting, sectioning, or a combination thereof. In an embodiment, the 3-PT star shard particle 902 can result from the manufacturing process of the 3-PT star-shaped abrasive particles 901 wherein precursor abrasive particles are fractured within a mold or broken during a de-molding process or similar such that the final 3-PT star-shaped abrasive particle is fractured, broken or is an otherwise incomplete 3-PT star-shaped abrasive particle shape. An exemplary molding process is shown in U.S. Pat. No. 5,009,676. In still another embodiment, the 3-PT star shard particles 902 can result from a different manufacturing process of the 3-PT star-shaped abrasive particles 901 such as a screen printing process wherein the precursor abrasive particles can fracture or break during the forming or post forming process when the precursor abrasive particles are removed from the belt, during drying, heating, or during any step of the forming process such that the 3-PT star-shaped abrasive particles 901 are fractured or broken. An exemplary screen printing process is shown in U.S. Pat. No. 8,753,742.

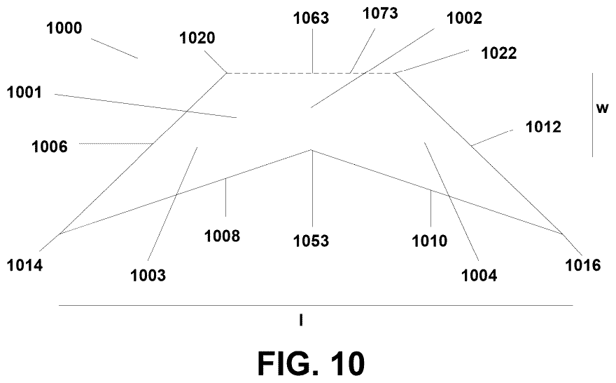

FIG. 10 includes a top view image of an exemplary 3-PT star shard particle according to a particular embodiment. As illustrated, the shaped abrasive particle 1000 can define a partial star-shaped body, as viewed in two dimensions. In particular, the 3-PT star shard particle 1000 can include a body 1001 having a central portion 1002 and a first arm 1003 and a second arm 1004 extending from the central portion 1002 and fractured surface 1073 wherein a portion of the shaped abrasive particle has been broken or fractured off. The body 1001 can have a length (l) measured as the longest dimension along a side of the particle and a width (w), measured as the longest dimension of the particle between a midpoint 1053 of a side through the central portion 1002 of the body 1001 to a midpoint 1063 of the fractured surface 1073. The width can extend in a direction perpendicular to the dimension of the length. In still other embodiments, the fractured surface 1073 can extend into the central portion 1002. This embodiment represents an embodiment wherein a greater portion of the body 1001 has been broken or fractured off.

In an embodiment, the 3-PT star shard particle 1000 can include a first side surface 1006 extending between a first tip 1014 and a first fracture end point 1020. In an embodiment, the 3-PT star shard particle 1000 can include a second side surface 1008 extending between a first corner 1014 and midpoint 1053. In an embodiment, the 3-PT star shard particle 1000 can include a third side surface 1010 extending between a midpoint 1053 and second corner 1016. In an embodiment, the 3-PT star shard particle 1000 can include a fourth side surface 1012 extending between a second corner 1016 and a second fracture end point 1022. In still another embodiment, the first side surface 1006 can have a length greater than a length of the fourth side surface 1012. In another embodiment, the first side surface 1006 can have a length less than a length of the fourth side surface 1012. In another embodiment, the first side surface 1006 can have a length equal to a length of the fourth side surface 1012. In an embodiment, the fractured surface 1073 can have a length shorter than a length of the first side surface 1006. In an embodiment, the fractured surface 1073 can have a length shorter than a length of the fourth side surface 1012. In an embodiment the fractured surface 1073 can have a length shorter than any length of the first 1006, second 1008, third 1010 or fourth 1012 side surfaces.

In an embodiment, the mixture may include a particular amount of bond material that may facilitate improved manufacturing and/or performance of the bonded abrasive. In a particular embodiment, the mixture may comprise at least about 5 wt % bond material for a total weight of the mixture, or at least 10 wt % or at least 15 wt % or at least 20 wt %. In another embodiment, the mixture includes no greater than about 60 wt % bond material for a total weight of the mixture or not greater than 50 wt % or not greater than 40 wt % or not greater than 30 wt % or not greater than 20 wt %. It will be appreciated that the content of bond material in the mixture can be within a range between any of the values noted above. In a particular embodiment, the mixture can include bond material within a range of about 10 wt % to about 95 wt % bond material for a total weight of the mixture.

In still other embodiments, the mixture can also include one of more filler materials. In certain aspects, the mixture can include at least about 5 wt % filler material for a total weight of the mixture, or at least 10 wt % or at least 15 wt % or at least 20 wt % or at least 25 wt % or at least 30 wt % or at least 35 wt % or at least 40 wt % for a total weight of the filler. In other aspects, the filler can include no greater than about 60 wt % filler material for a total weight of the filler, no greater than about 57 wt % filler material for a total weight of the filler, or no greater than about 52 wt % filler material for a total weight of the filler. It will be appreciated that the content of filler material can be within a range between any of the values noted above. In a particular illustrative embodiment, the content of filler material can be within a range of about 5 wt % filler material to about 60 wt % filler material for a total weight of the filler. It will be appreciated that the filler can include essentially zero filler materials.

The filler material can have a material selected from the group consisting of powders, granules, spheres, fibers, and a combination thereof. In one embodiment, the filler material can include a material selected from the group consisting of an inorganic material, an organic material, and a combination thereof. In a further embodiment, the filler material can include a material selected from the group consisting of sand, bubble alumina, bauxite, chromites, magnesite, dolomites, bubble mullite, borides, titanium dioxide, carbon products (e.g., carbon black, coke or graphite), wood flour, clay, talc, hexagonal boron nitride, molybdenum disulfide, feldspar, nepheline syenite, glass spheres, glass fibers, CaF₂, KBF₄, Cryolite (Na₃AlF₆), a potassium aluminum fluoride, such as potassium Cryolite (K₃AlF₆), pyrites, ZnS, copper sulfide, a material including Fe₂S, such as Pyrox, mineral oil, fluorides, carbonates, calcium carbonate, and a combination thereof.

At 104, the method 100 includes placing the mixture into a mold. The mold can be made of stainless-steel, high carbon-steel, high chrome-steel, another suitable material, or a combination thereof. In some situations, one or more layers of the mixture can be placed into the mold, such as by linear or rotational spreading. In an illustrative embodiment, other components, such as one or more reinforcement layers, can be placed above, below, or both above and below, at least one of the layers of the mixture. In certain embodiments, a reinforcement layer can comprise a material selected from the group consisting of an organic material, an inorganic material, and a combination thereof. Additionally, the reinforcement layer can comprise a material selected from the group consisting of a fabric, a fiber, a film, a woven material, a non-woven material, a glass, a fiberglass, a ceramic, a polymer, a resin, a polymer, a fluorinated polymer, an epoxy resin, a polyester resin, a polyurethane, a polyester, a rubber, a polyimide, a polybenzimidazole, an aromatic polyamide, a modified phenolic resin, and a combination thereof.

At 106, the method 100 includes applying a pressing process to the mixture while in the mold. In situations when multiple abrasive layers are formed, each of the abrasive layers can be subjected to a respective pressing process. The pressing process can include a cold pressing process, a warm pressing process, or a hot pressing process. In an illustrative embodiment, a warm pressing process can be applied at a temperature within a range of about 35° C. to about 75° C.

At 108, the method 100 includes heating the mixture to produce a bonded abrasive. In some embodiments, the heating of the mixture to produce the bonded abrasive may be optional.

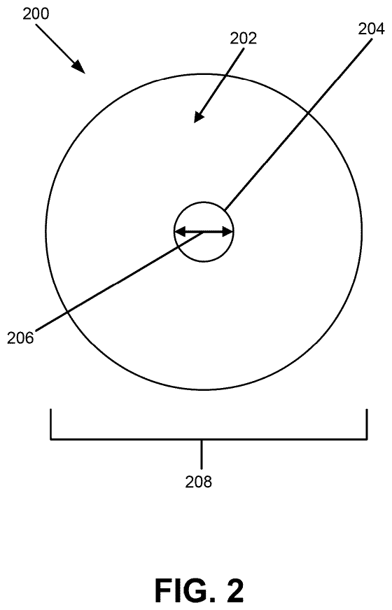

FIG. 2 includes a view of a bonded abrasive 200 in accordance with an embodiment. The bonded abrasive 200 includes a body 202 and a mounting hole 204 for mounting the bonded abrasive 200 to a cutting tool. A diameter 206 of the mounting hole 204 can be an inner diameter of the body 202 and the body 202 can have an outer diameter 208. In an embodiment, the outer diameter 208 can be at least about 220 mm, at least about 270 mm, at least about 310 mm, or at least about 360 mm. In another embodiment, the outer diameter 208 can be no greater than about 535 mm, no greater than about 457 mm, no greater than about 415 mm, or no greater than about 355 mm. It will be appreciated that the outer diameter 208 of the body 202 can be within a range between any of the values noted above.

In certain aspects, the inner diameter 206 can be at least about 35 mm, at least about 46 mm, or at least about 54 mm. In other instances, the inner diameter 206 can be no greater than about 90 mm, no greater than about 77 mm, or no greater than about 62 mm. It will be appreciated that the inner diameter 206 of the body 202 can be within a range between any of the values noted above.

The body 202 can also have a thickness of at least about 0.7 mm, at least about 1.5 mm, or at least about 1.9 mm. In some cases, the body can have a thickness of no greater than about 6.5 mm, no greater than about 5.7 mm, no greater than about 4.8 mm, no greater than about 3.5 mm, or no greater than about 2.2 mm. It will be appreciated that the thickness of the body 202 can be within a range between any of the values noted above. Furthermore, the body 202 can have a ratio of outer diameter 208 to thickness within a range between about 125:1 to about 15:1.

The body 202 can include materials included in the mixture used to form the bonded abrasive 200 as described previously with respect to FIG. 1. For example, the body 202 can include the abrasive particles provided in the mixture, the bond material provided in the mixture, and any other components provided in the mixture. Additionally, the body 202 can also include one or more abrasive layers including the abrasive particles contained within the bond material. In certain instances, one or more reinforcement layers can be positioned adjacent to the one or more abrasive layers. In certain constructions, one or more of the reinforcement layers can be overlying or underlying material for an abrasive layer. In at least one embodiment, a reinforcement layer can be in direct contact with an abrasive layer. In a particular embodiment, a reinforcement layer can be bonded directly to and at least partially impregnating portions of an abrasive layer. In other designs of embodiments herein, at least one abrasive layer (or a plurality of abrasive layers) can be disposed between a first reinforcement layer and a second reinforcement layer. According to one construction, a plurality of abrasive layers can be employed as discrete intervening layers separating at least first and second reinforcement layers. It will be appreciated that any combination of reinforcement layers and abrasive layers are contemplated herein.

In a particular embodiment, the body 202 can include a first group of abrasive particles. In an embodiment, the first group of abrasive particles can include shaped abrasive particles. In still another embodiment, the first group of abrasive particles can include shaped abrasive particles having a body having a 3-pointed star two-dimensional shape as viewed in a plane of a length and width of the body. Further, the first group of abrasive particles can have a first average particle size as described previously with respect to the first average particle size of the first group of abrasive particles of the mixture used to form the bonded abrasive 200.

The body 202 can also include a second group of abrasive particles. In an embodiment, the second group of abrasive particles can have a second average particle size as described previously with respect to the second average particle size of the second group of abrasive particles of the mixture.

In an embodiment, the body 202 can include a particular volume of abrasive particles that may facilitate improved manufacturing and/or performance of the bonded abrasive. In a particular embodiment, the body may have at least about 20 vol % abrasive particles for a total volume of the body 202, or at least 25 vol % or at least 30 vol % or at least 35 vol % or at least 40 vol %. In another embodiment, the body can include no greater than about 60 vol % abrasive particles for a total volume of the body 202, or not greater than 55 vol % or not greater than 50 vol % or not greater than 45 vol % or not greater than 40 vol % or not greater than 35 vol %. It will be appreciated that the content of abrasive particles of the body 202 can be within a range between any of the values noted above. In a particular illustrative embodiment, the body 202 can include abrasive particles within a range of about 20 vol % to about 60 vol % for a total volume of the body 202.

In an embodiment, the body 202 can include a particular volume of bond material that may facilitate improved manufacturing and/or performance of the bonded abrasive. In a particular embodiment, the body may have at least about 10 vol % bond material for a total volume of the body 202 or at least 20 vol % or at least 30 vol % or at least 40 vol % or at least 50 vol %. Additionally, the body can include no greater than about 70 vol % bond material for a total volume of the body 202, no greater than about 60 vol % bond material for a total volume of the body 202, or no greater than about 50 vol % bond material for a total volume of the body 202. It will be appreciated that the content of the bond material of the body 202 can be within a range between any of the values noted above. In a particular embodiment, the content of the bond material of the body 202 can be within a range of about 10 vol % to about 70 vol % for a total volume of the body 202.

In another embodiment, the body 202 can include at least about 2 vol % of the filler material for a total volume of the body 202, at least about 5 vol % of the filler material for a total volume of the body 202, or at least about 7 vol % of the filler material for a total volume of the body 202. Additionally, the body 202 can include no greater than about 16 vol % of the filler material for a total volume of the body 202, no greater than about 12 vol % of the filler material for a total volume of the body 202, or no greater than about 9 vol % of the filler material for a total volume of the body 202. It will be appreciated that the content of the filler material can be within a range between any of the values noted above. In a particular illustrative embodiment, the body 202 can include the filler material within a range of about 6 vol % to about 10 vol % for a total volume of the body 202.

In particular embodiments, the body 202 can include an amount of porosity, such as at least about 6 vol % porosity for a total volume of the body 202, at least about 11 vol % porosity for a total volume of the body 202, or at least about 14 vol % porosity for a total volume of the body 202 or at least 16 vol % or at least 18 vol % or at least 20 vol % or at least 22 vol % or at least 24 vol % or at least 26 vol % or at least 28 vol %. In additional cases, the body 202 can include no greater than about 30 vol % porosity for a total volume of the body 202, no greater than about 25 vol % porosity for a total volume of the body 202, or no greater than about 20 vol % porosity for a total volume of the body 202. It will be appreciated that the porosity of the body 202 can be within a range between any of the values noted above. In a particular illustrative embodiment, the porosity of the body 202 can be within a range of about 6 vol % to about 25 vol % for a total volume of the body 202.

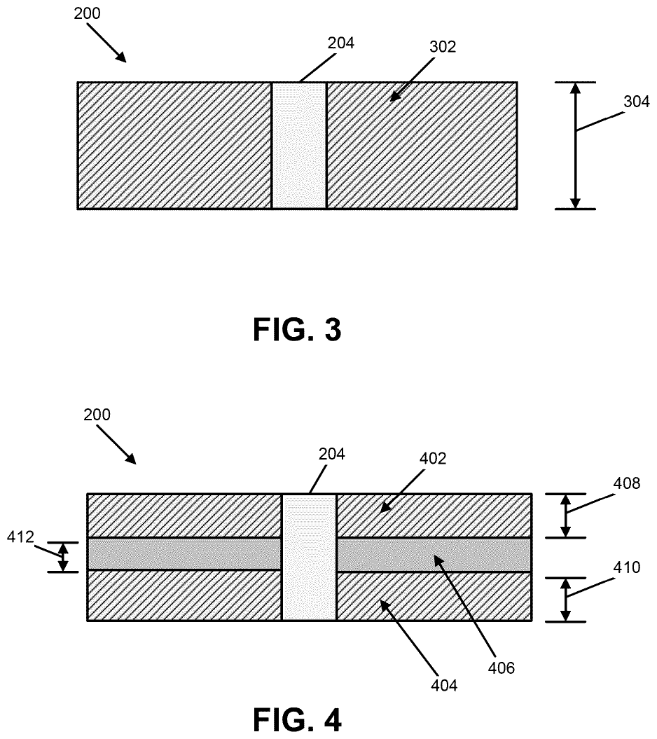

FIG. 3 includes a cross-sectional view of the bonded abrasive 200 of FIG. 2 according to an embodiment. In the illustrative embodiment of FIG. 3, the bonded abrasive has a mounting hole 204 and an abrasive layer 302. The abrasive layer 302 can include abrasive particles contained within a bond material. The abrasive layer 302 can also have a thickness 304.

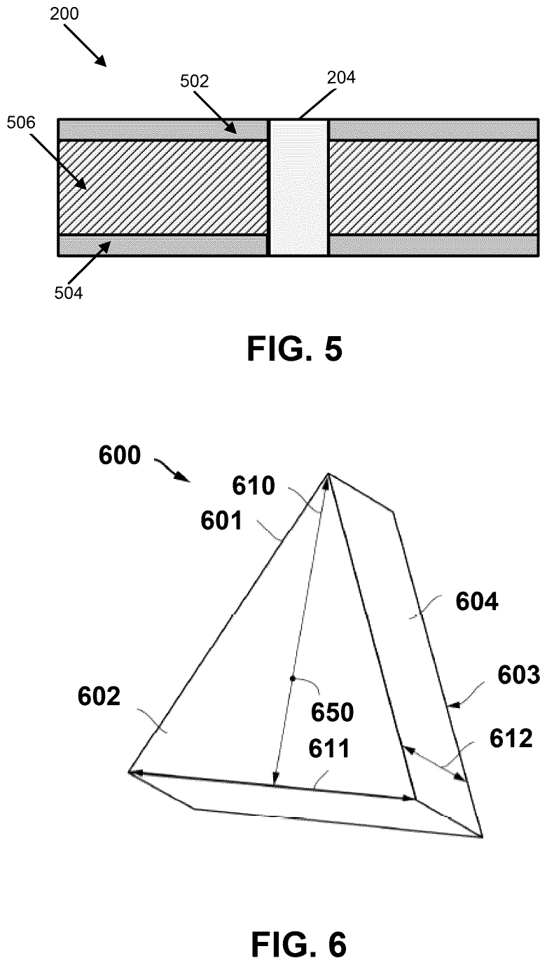

FIG. 4 includes a cross-sectional view of the bonded abrasive 200 of FIG. 2 in accordance with another embodiment. In the illustrative embodiment of FIG. 4, the bonded abrasive has a mounting hole 204, a first abrasive layer 402 and a second abrasive layer 404. The bonded abrasive 200 can also include a reinforcement layer 406. The first abrasive layer 402 and the second abrasive layer 404 can include abrasive particles contained within a bond material. In some cases, the content of abrasive particles and the content of bond material of the first abrasive layer 402 and the second abrasive layer 404 can be substantially the same, while in other situations, the content of the abrasive particles and the content of the bond material of the first abrasive layer 40 and the second abrasive layer 404 can be different.

The first abrasive layer 402 can have a thickness 408 and the second abrasive layer 404 can have a thickness 410. In addition, the reinforcement layer 406 can have a thickness 412. In some scenarios, the thickness 408 can be substantially the same as the thickness 410, while in other embodiments, the thickness 408 can be different from the thickness 410. Furthermore, the thickness 412 can be substantially the same or different with respect to the thickness 408, the thickness 410, or both.

FIG. 5 includes a cross-sectional view of the bonded abrasive 200 of FIG. 2 in accordance with an additional embodiment. In the illustrative embodiment of FIG. 2, the bonded abrasive 200 includes a mounting hole 204, a first reinforcement layer 502 and a second reinforcement layer 504. The bonded abrasive 200 also includes an abrasive layer 506.

### EMBODIMENTS

Embodiment 1. A bonded abrasive comprising:
a body including abrasive particles contained within a bond material, wherein the abrasive particles comprise:
a first group of abrasive particles in a first content (C1), the first group including shaped abrasive particles having a first average particle size (PS1); and
a second group of abrasive particles in a second content (C2), the second group including non-shaped abrasive particles having a second average particle size (PS2), wherein PS2<PS1; and a content ratio (C2/C1) of at least 0.05 to 1.

Embodiment 2. The bonded abrasive of Embodiment 1, wherein the first average particle size (PS1) is at least 200 microns or at least 210 microns or at least 220 microns or at least 230 microns or at least 240 microns or at least 250 microns or at least 260 microns or at least 270 microns or at least 280 microns or at least 290 microns or at least 300 microns or at least 310 microns or at least 320 microns or at least 330 microns or at least 340 microns or at least 350 microns or at least 400 microns or at least 450 microns or at least 500 microns or at least 550 microns or at least 600 microns or at least 650 microns or at least 700 microns or at least 750 microns or at least 800 microns or at least 850 microns or at least 900 microns or at least 950 microns or at least 1000 microns or at least 1050 microns or at least 1100 microns or at least 1150 microns or at least 1200 microns or at least 1250 microns or at least 1300 microns or at least 1350 microns or at least 1400 microns.

Embodiment 3. The bonded abrasive of Embodiment 1, wherein the first average particle size (PS1) is not greater than 3000 microns or not greater than 2500 microns or not greater than 2000 microns or not greater than 1900 microns or not greater than 1800 microns or not greater than 1700 microns or not greater than 1600 microns or not greater than 1500 microns or not greater than 1400 microns.

Embodiment 4. The bonded abrasive of Embodiment 1, wherein the second average particle size (PS2) is at least 1 micron or at least 5 microns or at least 10 microns or at least 20 microns or at least 30 microns or at least 40 microns or at least 50 microns or at least 60 microns or at least 70 microns or at least 80 microns or at least 90 microns or at least 100 microns or at least 110 microns or at least 120 microns or at least 130 microns or at least 140 microns or at least 150 microns or at least 160 microns or at least 170 microns or at least 180 microns or at least 190 microns.

Embodiment 5. The bonded abrasive of Embodiment 1, wherein the second average particle size (PS2) is not greater than 500 microns or not greater than 440 microns or not greater than 420 microns or not greater than 400 microns or not greater than 380 microns or not greater than 360 microns or not greater than 340 microns or not greater than 320 microns or not greater than or not greater than 300 microns or not greater than 280 microns or not greater than 260 microns or not greater than 240 microns or not greater than 220 microns or not greater than 200 microns or not greater than 190 microns.

Embodiment 6. The bonded abrasive of Embodiment 1, wherein the body comprises a particle size ratio (PS1:PS2) of the first average particle size (PS1) to the second average particle size (PS2) of at least 1 or at least 1.1 or at least 1.2 or at least 1.3 or at least 1.4 or at least 1.5 or at least 1.6 or at least 1.7 or at least 1.8 or at least. 1.9 or at least 2 or at least 3 or at least 4 or at least 5 or at least 6 or at least 7 or at least 8 or at least 9 or at least 10 or at least 11 or at least 12 or at least 13 or at least 14 or at least 15.

Embodiment 7. The bonded abrasive of Embodiment 1, wherein the body comprises a particle size ratio (PS1:PS2) of the first average particle size (PS1) to the second average particle size (PS2) of not greater than 20 or not greater than 19 or not greater than 18 or not greater than 17 or not greater than 16 or not greater than 15 or not greater than 14 or not greater than 13 or not greater than 12 or not greater than 11 or not greater than 10 or not greater than 9 or not greater than 8 or not greater than 7 or not greater than 6 or not greater than 5 or not greater than 4 or not greater than 3.

Embodiment 8. The bonded abrasive of Embodiment 1, wherein the first group of abrasive particles comprises a first content (C1) of at least about 50% for a total content of abrasive particles or at least 51% or at least 52% or at least 53% or at least 54% or at least 55% or at least 56% or at least 57% or at least 58% or at least 59% or at least 60% or at least 61% or at least 62% or at least 63% or at least 64% or at least 65% or at least 66% or at least 67% or at least 68% or at least 69% or at least 70%.

Embodiment 9. The bonded abrasive of Embodiment 1, wherein the first group of abrasive particles comprises a first content (C1) of not greater than about 90% for a total content of abrasive particles or not greater than 89% or not greater than 88% or not greater than 87% or not greater than 86% or not greater than 85% or not greater than 84% or not greater than 83% or not greater than 82% or not greater than 81% or not greater than 80% or not greater than 79% or not greater than 78% or not greater than 77% or not greater than 76% or not greater than 75%.

Embodiment 10. The bonded abrasive of Embodiment 1, wherein the second group of abrasive particles comprises a second content (C2) of at least about 10% for a total content of abrasive particles or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30%.

Embodiment 11. The bonded abrasive of Embodiment 1, wherein the second group of abrasive particles comprises a second content (C2) of not greater than about 50% for a total content of abrasive particles or not greater than 49% or not greater than 48% or not greater than 47% or not greater than 46% or not greater than 45% or not greater than 44% or not greater than 43% or not greater than 42% or not greater than 41% or not greater than 40% or not greater than 39% or not greater than 38% or not greater than 37% or not greater than 36% or not greater than 35% or not greater than 34% or not greater than 33% or not greater than 32% or not greater than 31% or not greater than 30%.

Embodiment 12. The bonded abrasive of Embodiment 1, wherein the body comprises a content ratio (C2/C1) of the second content (C2) to the first content (C1) of at least 0.11 or at least 0.2 or at least 0.3 or at least 0.4 or at least 0.41 or at least 0.42.

Embodiment 13. The bonded abrasive of Embodiment 1, wherein the body comprises a content ratio (C2/C1) of the second content (C2) to the first content (C1) of not greater than 0.99 or not greater than 0.95 or not greater than 0.9 or not greater than 0.85 or not greater than 0.8 or not greater than 0.75 or not greater than 0.7 or not greater than 0.65 or not greater than 0.6 or not greater than 0.55 or not greater than 0.5.

Embodiment 14. The bonded abrasive of Embodiment 1, wherein the shaped abrasive particles of the first group of abrasive particles have a body, and wherein each body comprises a length (l), a width (w), and a height (h), and wherein l>w>h.

Embodiment 15. The bonded abrasive of Embodiment 14, wherein the shaped abrasive particles of the first group of abrasive particles have a body, and wherein each body comprises a 3-pointed star two-dimensional shape as viewed in a plane of a length and width of the body.

Embodiment 16. The bonded abrasive of Embodiment 15, wherein the body of each shaped abrasive particle of the first group of abrasive particles comprises at least 3 exterior corners, wherein the sum of the angles of the exterior corners is less than 180 degrees.

Embodiment 17. The bonded abrasive of Embodiment 15, wherein the body of each shaped abrasive particle of the first group of abrasive particles comprises at least 3 exterior corners and at least 3 interior corners, wherein each of the interior corners have an interior corner angle value greater than any of the exterior corner values of any of the at least 3 exterior corners.

Embodiment 18. The bonded abrasive of Embodiment 15, wherein the body of each shaped abrasive particle of the first group of abrasive particles comprises a first arm, a second arm, and a third arm extending from a central portion.

Embodiment 19. The bonded abrasive of Embodiment 1, wherein the body of each shaped abrasive particle of the first group of abrasive particles comprises a ceramic material.

Embodiment 20. The bonded abrasive of Embodiment 19, wherein the body of each shaped abrasive particle of the first group of abrasive particles comprises at least one of a nitride, oxide, carbide, boride, oxynitride, oxyboride, diamond, carbon-containing material, or any combination thereof.

Embodiment 21. The bonded abrasive of Embodiment 20, wherein the body of each shaped abrasive particle of the first group of abrasive particles comprises an oxide compound or complex, such as aluminum oxide, zirconium oxide, titanium oxide, yttrium oxide, chromium oxide, strontium oxide, silicon oxide, magnesium oxide, rare-earth oxides, or any combination thereof.

Embodiment 22. A bonded abrasive comprising a body including abrasive particles contained within a bond material, wherein the abrasive particles comprise:
a first group of abrasive particles in a first content (C1);
a second group of abrasive particles in a second content (C2);
a content ratio (C2/C1) of at least 0.05 to 1; and
wherein the second group of abrasive particles comprise 3-PT star shard particles.

Embodiment 23. The bonded abrasive of embodiment 22, wherein the first group of abrasive particles comprises a first content (C1) of at least about 10% for a total content of abrasive particles or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 50%.

Embodiment 24. The bonded abrasive of Embodiment 22, wherein the first group of abrasive particles comprises a first content (C1) of not greater than about 90% for a total content of abrasive particles or not greater than 89% or not greater than 88% or not greater than 87% or not greater than 86% or not greater than 85% or not greater than 84% or not greater than 83% or not greater than 82% or not greater than 81% or not greater than 80% or not greater than 79% or not greater than 78% or not greater than 77% or not greater than 76% or not greater than 75% or not greater than 74% or not greater than 73% or not greater than 72% or not greater than 71% or not greater than 70% or not greater than 69% or not greater than 68% or not greater than 67% or not greater than 66% or not greater than 65% or not greater than 64% or not greater than 63% or not greater than 62% or not greater than 61% or not greater than 60% or not greater than 59% or not greater than 58% or not greater than 57% or not greater than 56% or not greater than 55% or not greater than 54% or not greater than 53% or not greater than 52% or not greater than 51% or not greater than 50%.

Embodiment 25. The bonded abrasive of Embodiment 22, wherein the second group of abrasive particles comprises a second content (C2) of at least about 10% for a total content of abrasive particles or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 50%.

Embodiment 26. The bonded abrasive of Embodiment 22, wherein the second group of abrasive particles comprises a second content (C2) of not greater than about 90% for a total content of abrasive particles or not greater than 89% or not greater than 88% or not greater than 87% or not greater than 86% or not greater than 85% or not greater than 84% or not greater than 83% or not greater than 82% or not greater than 81% or not greater than 80% or not greater than 79% or not greater than 78% or not greater than 77% or not greater than 76% or not greater than 75% or not greater than 74% or not greater than 73% or not greater than 72% or not greater than 71% or not greater than 70% or not greater than 69% or not greater than 68% or not greater than 67% or not greater than 66% or not greater than 65% or not greater than 64% or not greater than 63% or not greater than 62% or not greater than 61% or not greater than 60% or not greater than 59% or not greater than 58% or not greater than 57% or not greater than 56% or not greater than 55% or not greater than 54% or not greater than 53% or not greater than 52% or not greater than 51% or not greater than 50%.

Embodiment 27. The bonded abrasive of Embodiment 22, wherein the body comprises a content ratio (C2/C1) of the second content (C2) to the first content (C1) of at least 0.11 or at least 0.2 or at least 0.3 or at least 0.4 or at least 0.41 or at least 0.42 or at least 0.43 or at least 0.44 or at least 0.45 or at least 0.46 or at least 0.47 or at least 0.48 or at least 0.49 or at least 0.50.

Embodiment 28. The bonded abrasive of Embodiment 22, wherein the body comprises a content ratio (C2/C1) of the second content (C2) to the first content (C1) of not greater than 0.99 or not greater than 0.95 or not greater than 0.9 or not greater than 0.85 or not greater than 0.8 or not greater than 0.75 or not greater than 0.7 or not greater than 0.65 or not greater than 0.6 or not greater than 0.55 or not greater than 0.5.

Embodiment 29. The bonded abrasive of Embodiment 22, wherein the shaped abrasive particles of the first group of abrasive particles have a body, and wherein each body comprises a length (l), a width (w), and a height (h), and wherein l>w>h.

Embodiment 30. The bonded abrasive of Embodiment 29, wherein the shaped abrasive particles of the first group of abrasive particles have a body, and wherein each body comprises a 3-pointed star two-dimensional shape as viewed in a plane of a length and width of the body.

Embodiment 31. The bonded abrasive of Embodiment 30, wherein the body of each shaped abrasive particle of the first group of abrasive particles comprises at least 3 exterior corners, wherein the sum of the angles of the exterior corners is less than 180 degrees.

Embodiment 32. The bonded abrasive of Embodiment 30, wherein the body of each shaped abrasive particle of the first group of abrasive particles comprises at least 3 exterior corners and at least 3 interior corners, wherein each of the interior corners have an interior corner angle value greater than any of the exterior corner values of any of the at least 3 exterior corners.

Embodiment 33. The bonded abrasive of Embodiment 30, wherein the body of each shaped abrasive particle of the first group of abrasive particles comprises a first arm, a second arm, and a third arm extending from a central portion.

### EXAMPLES

### Example 1

Sample bonded abrasive wheels including a particular content of a first group of shaped abrasive particles and a second group of abrasive particles were formed. The first group of abrasive particles included shaped abrasive particles having a 3-pt star shape as shown in FIG. 8A having an average particle size of about 1400 microns. The second group of abrasive particles included 80-grit size brown fused alumina particles having an average particle size of 180 microns. Two mixes, mix A and B, were prepared having the compositions as shown in Table 1 using 0.22 wt % Cedarwood Oil as a wetting liquid add-in.

TABLE 1

| | Mix A | vol % | wt. % | Mix B | vol % | wt. % |
|---|---|---|---|---|---|---|
| abrasive | BFA-80 (2023-80), | 41.11% | 55.21% | 3-pt star | 41.11% | 55.21% |
| | (180 um diameter) | | | | | |
| resin | Liquid Resin: | 9.50% | 3.88% | Liquid Resin: | 9.50% | 3.88% |
| | Momentive > | | | Momentive > | | |
| | LR > D-AL- 132 LF | | | LR > D-AL- 132 LF | | |
| resin | Powder Resin: | 30.08% | 13.09% | Powder Resin: | 30.08% | 13.09% |
| | Durez 29318 | | | Durez 29318 | | |
| filler | CJD super active | 7.05% | 11.38% | CJD super active | 7.05% | 11.38% |
| | (MHP 325) | | | (MHP 325) | | |
| filler | CJF (fine iron | 7.05% | 11.38% | CJF (fine iron | 7.05% | 11.38% |
| | pyrite) | | | pyrite) | | |
| filler | Potassium Aluminum | 5.22% | 5.06% | Potassium Aluminum | 5.22% | 5.06% |
| | Fluoride | | | Fluoride | | |

Portions of mix A and mix B were combined at various ratios and pressed into wheels. Sample 1 had a ratio of 100:0 of mix A to mix B, Sample 2 had a 10:90 ratio of mix A to mix B, Sample 3 had a 40:60 ratio of mix A to mix B, Sample 4 had a 70:30 ratio of mix A to mix B, Sample 5 had a 80:20 ratio of mix A to mix B and Sample 6 had a 100:0 ratio of mix B to mix A. The six wheel samples had the abrasive particle contents as shown in Table 2.

TABLE 2

| | % first group | % second group | Average # |
|---|---|---|---|
| | abrasive particles | abrasive particles | of cuts |
| Sample 1 | 0 | 100 | 5 |
| Sample 2 | 10 | 90 | 6 |
| Sample 3 | 40 | 60 | 12 |
| Sample 4 | 70 | 30 | 15 |
| Sample 5 | 80 | 20 | 11 |
| Sample 6 | 100 | 0 | 7 |

Samples 1-6 are used to cut a 4-inch wide by 0.25-inch thick (101.6 mm×6.35 mm) carbon steel workpiece with a Metabo W12 cutting tool. The sample wheels all had a diameter of 125 mm and 1.7 mm thickness. The cutting tool is operated at a speed of about 9,000 rotations per minute when free spinning and about 6,000 rotations per minute when cutting with a working current of about 9-11 amps. The results of the total number of cuts prior to the wheel failing are provided in Table 2.

### Example 2

Sample bonded abrasive wheels including a particular content of a first group of shaped abrasive particles and a second group of abrasive particles were formed. The first group of abrasive particles included shaped abrasive particles having a 3-pt star shape as shown in FIG. 8A having an average particle size of about 1400 microns. The second group of abrasive particles included 3-pt star shard particles 902 as shown in FIG. 9. Two mixes, mix B and C, were prepared having the compositions as shown in Table 1 and Table 2 using 0.22 wt % Cedarwood Oil as a wetting liquid add-in.

TABLE 3

| | Mix C | vol % | wt. % |
|---|---|---|---|
| abrasive | 3-PT star shards | 41.11% | 55.21% |
| resin | Liquid Resin: Momentive > LR >D-AL- 132 | 9.50% | 3.88% |
| | LF | | |
| resin | Powder Resin: Durez 29318 | 30.08% | 13.09% |
| filler | CJD super active (MHP 325) | 7.05% | 11.38% |
| filler | CJF (fine iron pyrite) | 7.05% | 11.38% |
| filler | Potassium Aluminum Fluoride | 5.22% | 5.06% |

Portions of mix B and mix C were combined at various ratios and pressed into wheels. Sample 7 had a ratio of 100:0 of mix B to mix C, Sample 8 had a 100:0 ratio of mix B to mix C, and Sample 9 had a ratio of 50:50 of mix B to mix C. The three wheel samples had the abrasive particle contents as shown in Table 4.

TABLE 4

| | % first group | % second group | Average # |
|---|---|---|---|
| | abrasive particles | abrasive particles shard | of cuts |
| Sample 7 | 100 | 0 | 8 |
| Sample 8 | 0 | 100 | 18 |
| Sample 9 | 50 | 50 | 24 |

Samples 7 to 9 are used to cut a 4-inch wide by 1.25-inch thick (101.6 mm×32 mm) carbon steel workpiece with a Metabo W12 cutting tool. The sample wheels all had a diameter of 76 mm and 1.7 mm thickness. The cutting tool is operated at a speed of about 9,000 rotations per minute when free spinning and about 6,000 rotations per minute when cutting with a working current of about 9-11 amps. The results of the total number of cuts prior to the wheel failing are provided in Table 4.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A bonded abrasive comprising:
a body including abrasive particles contained within a bond material, wherein the abrasive particles comprise:
a first group of abrasive particles in a first content (C1), the first group including shaped abrasive particles having a first average particle size (PS1); and
a second group of abrasive particles in a second content (C2), the second group including non-shaped abrasive particles having a second average particle size (PS2), wherein PS2<PS1; and
a content ratio (C2/C1) of at least 0.05 to 1.

2. The bonded abrasive of claim 1, wherein the first average particle size (PS1) is at least 200 microns.

3. The bonded abrasive of claim 1, wherein the first average particle size (PS1) is not greater than 3000 microns.

4. The bonded abrasive of claim 1, wherein the second average particle size (PS2) is at least 1 micron.

5. The bonded abrasive of claim 1, wherein the second average particle size (PS2) is not greater than 500 microns.

6. The bonded abrasive of claim 1, wherein the body comprises a particle size ratio (PS1:PS2) of the first average particle size (PS1) to the second average particle size (PS2) of at least 1.

7. The bonded abrasive of claim 1, wherein the body comprises a particle size ratio (PS1:PS2) of the first average particle size (PS1) to the second average particle size (PS2) of not greater than 20.

8. The bonded abrasive of claim 1, wherein the first group of abrasive particles comprises a first content (C1) of at least about 50% for a total content of abrasive.

9. The bonded abrasive of claim 1, wherein the first group of abrasive particles comprises a first content (C1) of not greater than about 90% for a total content of abrasive particles.

10. The bonded abrasive of claim 1, wherein the second group of abrasive particles comprises a second content (C2) of at least about 10% for a total content of abrasive particles.

11. The bonded abrasive of claim 1, wherein the second group of abrasive particles comprises a second content (C2) of not greater than about 50% for a total content of abrasive particles.

12. The bonded abrasive of claim 1, wherein the body comprises a content ratio (C2/C1) of the second content (C2) to the first content (C1) of at least 0.11.

13. The bonded abrasive of claim 1, wherein the body comprises a content ratio (C2/C1) of the second content (C2) to the first content (C1) of not greater than 0.99.

14. The bonded abrasive of claim 1, wherein the shaped abrasive particles of the first group of abrasive particles have a body, and wherein each body comprises a length (l), a width (w), and a height (h), and wherein l>w>h.

15. The bonded abrasive of claim 14, wherein the shaped abrasive particles of the first group of abrasive particles have a body, and wherein each body comprises a 3-pointed star two-dimensional shape as viewed in a plane of a length and width of the body.

16. The bonded abrasive of claim 15, wherein the body of each shaped abrasive particle of the first group of abrasive particles comprises at least 3 exterior corners, wherein the sum of the angles of the exterior corners is less than 180 degrees.

17. The bonded abrasive of claim 15, wherein the body of each shaped abrasive particle of the first group of abrasive particles comprises at least 3 exterior corners and at least 3 interior corners, wherein each of the interior corners have an interior corner angle value greater than any of the exterior corner values of any of the at least 3 exterior corners.

18. The bonded abrasive of claim 15, wherein the body of each shaped abrasive particle of the first group of abrasive particles comprises a first arm, a second arm, and a third arm extending from a central portion.

19. (canceled)

20. (canceled)

21. (canceled)

22. A bonded abrasive comprising:
a body including abrasive particles contained within a bond material, wherein the abrasive particles comprise:
a first group of abrasive particles in a first content (C1);
a second group of abrasive particles in a second content (C2);
a content ratio (C2/C1) of at least 0.05 to 1; and
wherein the second group of abrasive particles comprise 3-PT star shard particles.

23. The bonded abrasive of claim 22, wherein the content ratio (C2/C1) is at least 0.5 to not greater than 1.

24. The bonded abrasive of claim 22, wherein the content ratio (C2/C1) is 1.
